(19) United States
(12) Patent Application Publication
(10) Pub. No.: US 2026/0219050 A1
(43) Pub. Date: Jul. 30, 2026

(54) NAVIGATION DEVICE AND METHOD USING CORRECTION DATA IN A REMOTE IMU

(71) Applicant: SAFRAN ELECTRONICS & DEFENSE, PARIS (FR)

(72) Inventor: Yves BECHERET, MOISSY-CRAMAYEL (FR)

(21) Appl. No.: 19/142,050

(22) PCT Filed: Dec. 12, 2023
(86) PCT No.: PCT/EP2023/085234

§ 371 Date: Jun. 20, 2025

(30) Foreign Application Priority Data
Dec. 21, 2022 (FR) 2214141

(51) Int. Cl. G01C 21/28

(52) U.S. Cl. CPC G01C 21/28

(57) ABSTRACT

Navigation device including an inertial measurement unit and an electronic navigation calculation unit that are connected to each other by a data link, the inertial measurement unit having inertial sensors for producing location signals, and the electronic navigation calculation unit arranged to calculate a navigation from the location signals. The inertial measurement unit has an electronic processing circuit connected to the inertial sensors and with a memory containing an error model of the inertial measurement unit. The electronic processing circuit is arranged to transmit to the electronic navigation unit, firstly, at a first rate, said location signals and, secondly, at a second rate, correction signals having first correction data, which are representative of an impact of the sensor errors on the location signals over a given period and which are determined by the electronic processing circuit on the basis of the error model, and second correction data, which are representative of an effect of the random noises and errors of the inertial measurement unit over the given period. The electronic navigation calculation unit implements a hybrid navigation algorithm arranged to supply a hybrid location that is based on inertial location data extracted from the location signals and from the external location data and that is readjusted on the basis of the correction data.

The present invention relates to the field of inertial measurement units, more particularly to inertial navigation systems enabling navigation on the basis of measurements supplied by at least one inertial measurement unit.

### BACKGROUND OF THE INVENTION

Inertial navigation systems are known; one example is shown in FIG. 7 under the general reference 1000, comprising, within the same housing, an inertial measurement unit 1100 that is connected by a data link to an electronic navigation calculation unit 1200.

The inertial measurement unit 1100 comprises accelerometers and angular sensors arranged along the axes of a measurement frame of reference [m] for supplying primary signals that are representative of the integral, over a time step (for example between a time tᵢ₋₁ and a time tᵢ), of the specific force vector and the angular velocity vector with respect to an inertial frame of reference [i]. The successive signals are thus representative of the integral of both the specific force vector and the angular velocity vector from a time t₀ to a time t₁, then from the time tᵢ to a time t₂, then from the time t₂ to a time t₃, etc.; the signals are therefore generally called increments. The specific force (“g-force” or “mass-specific force”) is a representation of the sum of, on the one hand, the acceleration of the carrier of the inertial measurement unit relative to the inertial frame of reference and, on the other hand, the Earth's gravity.

The electronic navigation calculation unit 1200 comprises a processor and a memory containing a navigation computer program that is executed by the processor and that processes the signals supplied by the inertial measurement unit 1100 in order to determine a trajectory of the carrier (a vehicle) carrying the navigation system. Since the primary signals supplied by the inertial measurement unit 1100 are increments indicative of a variation in the location of the carrier and not an absolute value, the navigation calculations have to be carried out at a high rate, typically from 50 to 200 Hz, in order to ensure that the location is precisely reconstructed in a manner insensitive to the dynamics of the carrier. A clock 1001 allows the inertial measurement unit 1100 and the electronic navigation calculation unit 1200 to be synchronised.

It is understood that a loss of signal, even only briefly, between the inertial measurement unit and the electronic navigation calculation unit is very detrimental since some of the increments are not used.

To improve navigation precision, it has been envisaged to use more expensive inertial sensors, optimise the electronic processing of the signals, use more reliable data links between the inertial measurement unit and the electronic navigation unit when these are far apart from one another, etc.

It is also known to use external location data, for example from a satellite navigation system (GNSS systems such as GPS, GALILEO, GLONASS, BEIDOU, etc.), an aerodynamic data computer (baro-altimeter, Pitot tube, etc.), a star tracker device, etc. These external data are then used periodically to initialise or readjust the inertial navigation. This is referred to as the alignment or harmonisation phase (dockside alignment of a ship) and hybridised (or hybrid) navigation.

### OBJECT OF THE INVENTION

The object of the invention is in particular to improve the performance of hybrid navigation.

### SUMMARY OF THE INVENTION

To this end, a navigation device is provided, comprising an inertial measurement unit and an electronic navigation calculation unit that are connected to each other by a data link. The inertial measurement unit comprises inertial sensors for producing location signals, and the electronic navigation calculation unit is arranged to calculate a navigation from the location signals. The inertial measurement unit comprises an electronic processing circuit that is connected to the inertial sensors and provided with a memory containing an error model of the inertial measurement unit. The electronic processing circuit is arranged to transmit to the electronic navigation unit, firstly, at a first rate, said location signals and, secondly, at a second rate, correction signals comprising first correction data, which are representative of an impact of the sensor errors on the location signals over a given period and are determined by the electronic processing circuit from the error model, second data, and correction which are representative of an effect of the random noises and errors of the inertial measurement unit over the given period. The electronic navigation calculation unit implements a hybrid navigation algorithm arranged to supply a hybrid location which is based on inertial location data extracted from the location signals and the external location data and which is readjusted on the basis of the correction data.

The term “location signals” refers to signals comprising location data for calculating the location of the vehicle. Thus, the electronic processing circuit is capable of supplying the location signals and the correction signals to the electronic navigation calculation unit, thereby enabling the electronic navigation calculation unit to generate a corrected hybrid navigation and thus to have better performance, in particular for real-time implementation of, for example, a plurality of hybridisations and associated navigations concurrently.

Preferably, the electronic processing circuit is arranged to perform at least a first integration, as a function of time, of primary data contained in primary signals from the inertial sensors over an integration period, which begins at a single integration start time and is measured, in order to produce processed data inserted into signals forming the location signals together with time information representative of the integration period, and in that the electronic navigation calculation unit is arranged to extract the processed data and the time information from the location signals and to process them in order to calculate the navigation while taking the integration period into account.

It is no longer the primary signals (the increments produced by the inertial sensors) which are transmitted at a high rate to the electronic navigation calculation unit as in the prior art, but rather values which are integrated over an unbounded integration period from the single integration time (the same for all the processed data, corresponding for example to the start-up of the system or to the receipt of an integration start command) and which can be transmitted at the same rate or at a lower rate. It is understood that the location signals successively sent by the electronic processing circuit are representative of an integration of the time to at a time t₁, then of the time to at a time t₂, then of the time to at a time t₃, etc. In this way, whatever the time is when a location signal is received, it is representative of an integration starting from the single integration start time. The navigation error in the event of a receive fault of one or more data frames is greatly reduced by comparison with, for example, a conventional method that involves extrapolation from conventional velocity and angle increment data received before and after the transmission fault. The transmission of the data in accordance with the invention is therefore less restrictive while limiting the consequences of a transmission error. Processing the data to form the location signals that will be transmitted therefore makes it possible to increase the reliability of the transmission of the data and of the navigation calculation carried out on the basis of said data. Such transmission is advantageous over short distances but also over relatively long distances (several metres).

Advantageously, the electronic processing circuit is arranged to:
perform a first integration of at least a portion of the primary data, a second integration on the result of the first integration, and a third integration on the result of the second integration;
calculate, from the results of the first integration and the results of the second integration, a transfer matrix for transferring from the inertial frame of reference to the navigation frame of reference in the form of a first matrix composed of the coefficients of the Legendre polynomials of order 0 and a second matrix composed of the coefficients of the Legendre polynomials of order 1;
calculate, from the result of the third integration, the coefficients of the Legendre polynomials of order 2 of a third matrix added to the sum of the previous ones in order to refine the calculation of the transfer matrix.

The invention also relates to a method for navigating by means of a navigation device comprising an inertial measurement unit and an electronic navigation calculation unit that are connected to each other by a data link, comprising the steps of:
in the inertial measurement unit:
   generating location signals from measurements of inertial sensors and transmitting the location signals to the electronic navigation calculation unit at a first rate,
   generating, from an inertial sensor error model stored in the inertial measurement unit, correction signals comprising first correction data, which are representative of an impact of the sensor errors on the location signals over a given period, and second correction data, which are representative of the dynamic noises representing the model errors over the given period, and transmitting the correction signals to the electronic navigation calculation unit at a second rate; and
in the electronic navigation calculation unit:
   calculating, by using a hybrid navigation algorithm, a hybrid location that is based on inertial location data extracted from the location signals and the external location data,
   readjusting the hybrid location on the basis of the correction data.

More specifically, in a preferred embodiment, the electronic navigation unit is arranged to:
calculate, at a low rate (i.e. lower than the rate at which the location signals are transmitted), the evolution of a hybrid location which is based on inertial location data, current errors of the inertial measurement unit estimated by the hybrid navigation algorithm, and the first correction data;
calculate, at the low rate, the evolution of the error statistics of the hybrid navigation and of the errors of the inertial measurement unit (for example in the form of a covariance matrix for hybridisation by a Kalman filter), from the inertial location data, the current errors of the inertial measurement unit estimated by the hybrid navigation algorithm, and the first and second correction data;
readjust, at the low rate, the estimated errors of the inertial navigation and of the inertial measurement unit, using the location data at the readjustment time and, preferably, available external dated data for improving the location precision.

Also preferably, the first correction data are the components of the evolution matrix PHI of the error of the inertial location and of the inertial measurement unit at the low rate, and the second correction data are the components of the random evolution matrix Q of the error of the inertial location and of the inertial measurement unit at the low rate. The matrix Q is also commonly referred to as a desensitisation matrix or noise matrix.

Lastly, the invention relates to a vehicle having a navigation device according to the invention.

Other features and advantages of the invention become clear on reading the following description of a particular and non-limiting embodiment of the invention.

### BRIEF DESCRIPTION OF THE DRAWINGS

Reference is made to the accompanying drawings, in which:

FIG. 1 is a schematic partial view of an aircraft having a navigation device according to the invention;

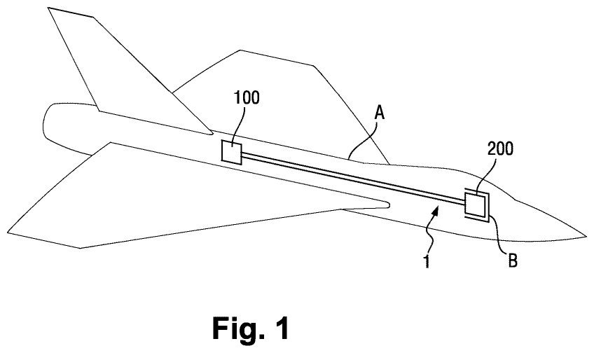

FIG. 2 is a schematic view of the device according to the invention;

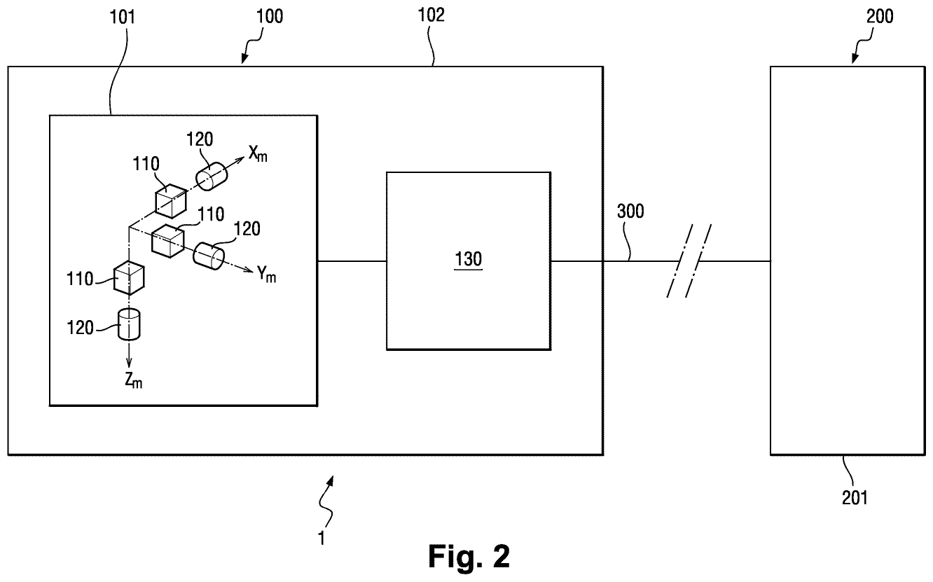

FIG. 3 is a flowchart showing the data exchanges when the method according to the invention is carried out;

FIG. 4 is a flowchart showing the implementation of the method according to the invention, on the inertial measurement unit side;

FIG. 5 is a flowchart showing the implementation of the method according to the invention, on the electronic calculation unit side, for processing the location signals;

FIG. 6 is a flowchart showing the implementation of the method according to the invention, on the electronic calculation unit side, for processing the correction signals;

FIG. 7 is a flowchart showing the data exchanges in a navigation device according to the prior art.

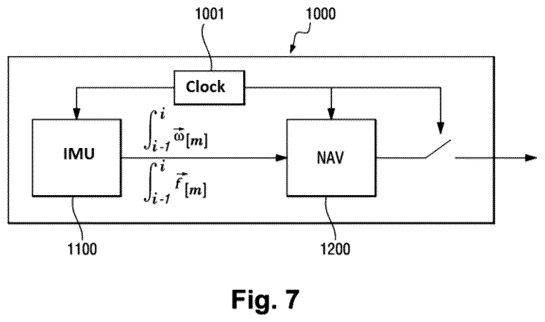

### DETAILED DESCRIPTION OF THE INVENTION

With reference to the drawings, the invention is described here in an aeronautical application, the navigation device of the invention being on board an aircraft A having a structure that comprises a fuselage and wings and having a centre of gravity G.

The navigation device according to the invention, denoted generally by 1, comprises an inertial measurement unit 100 and an electronic navigation calculation unit 200 that are connected to each other by a data link 300. Here, the inertial measurement unit 100 is positioned substantially at the centre of gravity G of the aircraft A, and the electronic calculation unit 200 is positioned at the front of the aircraft A, in an avionics bay B that contains the computers that process the data used for piloting the aircraft A. Thus, the inertial measurement unit 100 is arranged at a first distance from the centre of gravity G, and the electronic navigation calculation unit 200 is arranged at a second distance from the centre of gravity, the first distance being less than the second distance in this case. Here, the difference between the first distance and the second distance is several metres.

The inertial measurement unit 100 comprises a first housing 101 containing inertial sensors, namely linear inertial sensors (more specifically accelerometers 110), arranged along the axes of a measurement frame of reference [m] for measuring the “gravitational velocity” of that frame of reference (i.e. the time integral of the specific force present at the centre of the frame of reference), and also angular inertial sensors (in this case gyroscopes 120) arranged along the axes of said frame of reference to measure the rotation of the measurement frame of reference [m] with respect to an inertial frame of reference [i]. The inertial sensors do not supply absolute values but rather increments representative of a variation in the measured quantity compared with the previous measurement. The increments of the integral of the specific force are thus representative of a variation in the components of the gravitational velocity along the three axes of the frame of reference [m]. The rotational increments are thus representative of the variation in the time integral of the angular rotational velocity of the measurement frame of reference [m] with respect to the inertial frame of reference [i] and are supplied in the form of quaternions (rotational transfer quaternion Qi/m for transferring from [m] to [i]), Euler angles, rotation matrices or Bortz vectors. The inertial sensors thus supply first signals or primary signals containing first data representative of a variation in the gravitational velocity (accelerometric measurement) and second data representative of an angle variation (gyroscopic measurement). Conventionally, these signals are supplied at a rate of between 100 Hz and 400 Hz.

The first housing 101 is received in a second housing 102 of the inertial measurement unit 100. The second housing 102 also contains an electronic processing circuit 130 having inputs connected to the outputs of the inertial sensors 110, 120, for example by electrical conductors such as printed circuit tracks or cables. Here, the electronic processing circuit 130 comprises at least one processor and one memory containing a first computer program which is executable by the processor and which comprises instructions arranged to carry out the method of the invention. This first program will be explained further below.

The electronic navigation calculation unit 200 is known per se and comprises a housing 201 that contains at least one processor and one memory containing a second computer program which is executable by the processor and which comprises instructions arranged to carry out the method of the invention. In general, the electronic navigation calculation unit 200 is arranged to calculate a navigation from signals supplied by the inertial measurement unit 100. This second program will also be explained further below.

The inertial measurement unit 100 and the electronic navigation calculation unit 200 each have a clock that allows firstly the transmitted signals and secondly the receipt times to be dated.

The inertial measurement unit 100 and the electronic navigation calculation unit 200 are physically separated from each other but are connected so as to exchange signals. Thus, the electronic processing circuit 130 has at least one output connected to at least one input of the electronic navigation calculation unit 200 via a data link 300. Here, the data link 300 is an Ethernet link in accordance with the ARINC664 standard, for example.

The inertial measurement unit 100 is arranged to supply the electronic navigation calculation unit with two types of signals: location signals and correction signals, which will both be explained further below.

The generation of the location signals will be explained first.

Specifically, the first program supplies location signals at the times tᵢ at a first rate and location signals at the times tₖ at a second rate, which is lower than the first rate in this case.

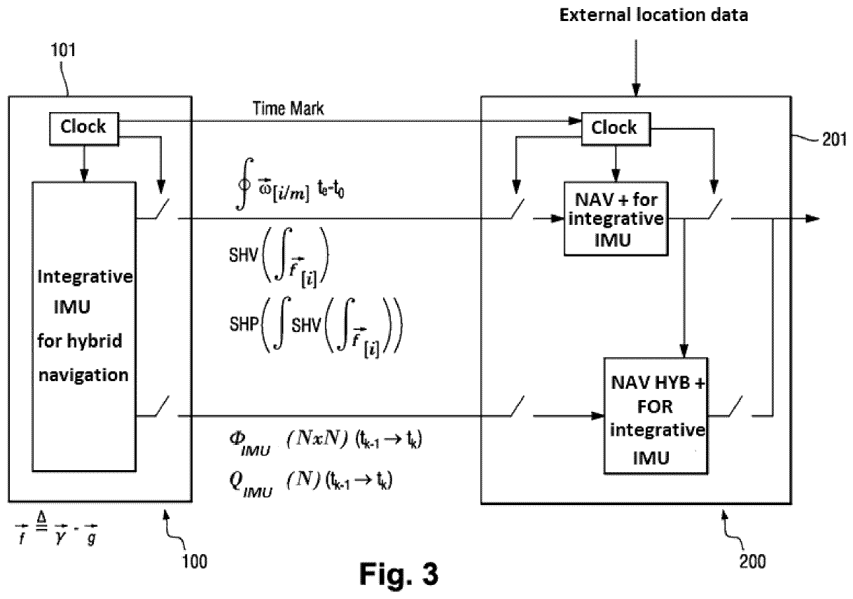

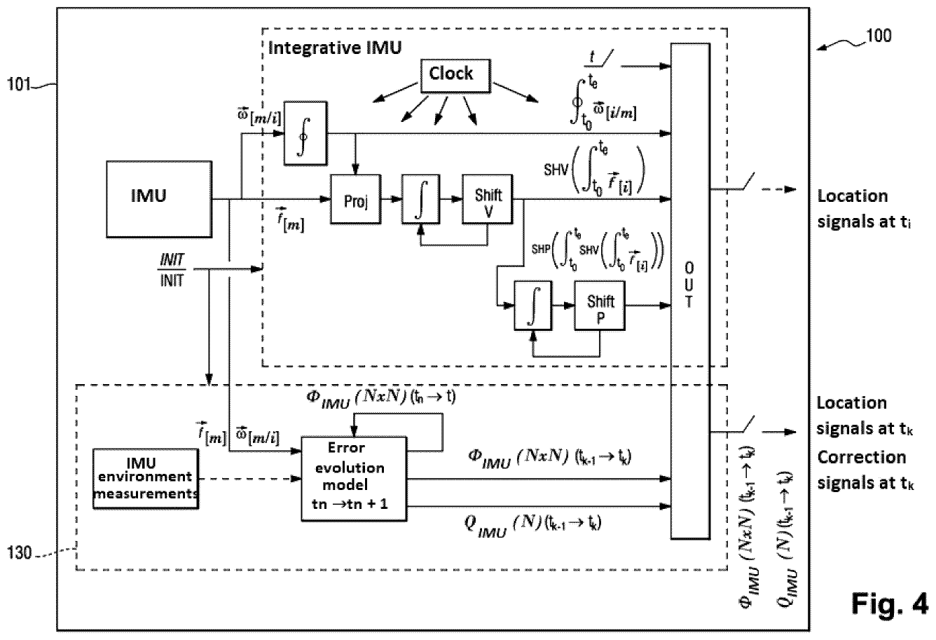

The first program executed by the electronic processing circuit 130 receives, as an input, the first signals containing the first data and the second data. To form the location signals at tᵢ, the first program is arranged to perform:
a first integration, over an integration period measured from a single integration start time to (length of time denoted by tₑ-t₀ in FIGS. 3 and 4, with i varying from 0 to e), of the second data in order to produce second integrated data;
a projection of the first data into the inertial frame of reference [i] in order to obtain first projected data;
a first integration of the first projected data, over the integration period measured from the single integration start time to, in order to produce first integrated data;
a first shift (Shift V or SHV) of the first integrated data in order to obtain first processed data (the first shift is performed when the value of the first integrated data exceeds a value range that is acceptable for the subsequent processing of said data);
a second integration of the first processed data, over the integration period measured from the single integration start time to, in order to produce first double-integrated data;
a second shift (Shift P or SHP) of the first double-integrated data in order to obtain first double-processed data (the second shift is performed when the value of the first double-integrated data goes beyond a value range that is acceptable for the subsequent processing of said data).

The inertial frame of reference [i] is, for example, the measurement frame of reference [m] when the inertial measurement unit 100 is powered up, or any other inertial frame of reference angularly shifted with respect thereto, for example the frame of reference [m] at the integration start or end time.

The first program executed by the electronic processing circuit is arranged to calculate the floating-point or fixed-point integrations using a number of mantissa bits that makes it possible to achieve the required location precision with a minimum time between two successive shifts of 20 s. A double-precision calculation on 64 bits, of which 48 are mantissa bits, makes it possible to achieve a precision goal of, for example, 0.001 m·s⁻¹, 0.001 m, 0.001°/h and 1 μrad.

It is understood that:
the second integrated data are representative of an angular position (or an orientation);
the first integrated data and the first processed data are representative of a linear velocity;
the first double-integrated data and the first double-processed data are representative of a linear position.

The first shifting operation comprises the step of comparing an absolute initial value of each component of the first integrated data with at least one first threshold SVelocity. When the components of the first integrated data have absolute current values below the first threshold, the first program leaves the current values unchanged, which is equivalent to applying a zero shift. When one of the components of the first integrated data has an absolute current value that reaches or exceeds the first threshold, the first program applies a predetermined shift to said component of the first integrated data in order to bring said component of the first integrated data to a shifted value below the first threshold. In other words, a first shift value SHV (here equal to the first threshold) is deduced from the initial value of said component of the first integrated data (or added to it depending on the sign of the current value) in order to obtain the shifted value. This makes it possible to keep the value of each component of the first data within a value range [−SVelocity; +SVelocity]. The first threshold SVelocity is determined depending on an expected velocity resolution for the navigation. The shift-free integration period obviously depends on the dynamics of the aircraft A. Here, the first integrated data and the first shift value SHV are expressed in metres per second.

The second shifting operation comprises the step of comparing an absolute current value of the first double-integrated data with at least one second threshold SPosition. When the components of the first double-integrated data have absolute current values below the second threshold, the first program leaves the current values unchanged, which is equivalent to applying a zero shift. When the value of one of the components of the first double-integrated data reaches or exceeds the second threshold, the first program applies a predetermined shift to said component of the first double-integrated data in order to bring said component of the first double-integrated data to a shifted value below the second threshold. In other words, a second shift value SHP (here equal to the second threshold) is deduced from the initial value of the first double-integrated data (or added to it depending on the sign of the initial value of said component) in order to obtain the shifted value. This makes it possible to keep the value of each component of the first double-integrated data within a value range [−SPosition; +SPosition]. The second threshold SPosition is determined depending on an expected position resolution for the navigation. The shift-free integration period depends on the dynamics of the aircraft A and the threshold SVelocity. Here, the first double-integrated data and the second shift value SHP are expressed in metres.

The first processed data (which correspond to the three velocity components including the integration of the effect of gravity, which may be affected by a shift and are thus referred to as the pseudo-velocity PV or inertial pseudo-velocity PVI), the first double-processed data (which correspond to the three position components including the double integration of the effect of gravity, which may be affected by one shift—velocity or position—or by two shifts—velocity and position—and are thus referred to as the pseudo-position PP or inertial pseudo-position PPI), the second processed data (which correspond to the three components of the rotation that is representative of the attitude of the aircraft A) and time information (an integration-step or time-step counter of the inertial measurement unit between the sampling time and the single integration start time, i.e. tₑ-t₀ here) are transformed into a packet that is introduced into second signals at tᵢ transmitted via the data link 300 to the electronic navigation calculation unit 200. These second signals at tᵢ are the location signals at tᵢ (also called inertial pseudo-location signals).

To form the location signals at tr, the first program is arranged to perform:
a first integration, over an integration period measured from the previous time tₖ₋₁ (length of time denoted by tₖ₋₁−tₖ in FIGS. 3 and 4), of the second data in order to produce second integrated data;
a projection of the first data into the inertial frame of reference [i] in order to obtain first projected data;
a first integration of the first projected data, over the integration period measured from the time tₖ₋₁, in order to produce first integrated data;
a second integration of the first integrated data, over the integration period measured from the time tₖ₋₁, in order to produce first double-integrated data;
a third integration of the first integrated data, over the integration period measured from the time tₖ₋₁, in order to produce first double-integrated data.

A batch of location data from tₖ₋₁ to tₖ is thus obtained, in which:
the second integrated data from tₖ₋₁ to tₖ are representative of an increment in an angular position (or in an orientation);
the first integrated data from tₖ₋₁ to tₖ are representative of a linear velocity increment;
the first double-integrated data from tₖ₋₁ to tₖ are representative of a linear position increment;
the first triple-integrated data from tₖ₋₁ to tₖ are used to improve the precision, as will be seen later.

The location signals at tₖ may also include:
a first integration, over an integration period measured from the single integration time to (or tₖ−t₀), of the second data in order to produce second integrated data;
a projection of the first data into the inertial frame of reference [i] in order to obtain first projected data;
a first integration of the first projected data, over the integration period measured from the single integration time t₀, in order to produce first integrated data;
a first shift (Shift V or SHV) of the first integrated data in order to obtain first processed data (the first shift is performed when the value of the first integrated data exceeds a value range that is acceptable for the subsequent processing of said data);
a second integration of the first processed data, over the integration period measured from the single integration start time to, in order to produce first double-integrated data;
a second shift (Shift P or SHP) of the first double-integrated data in order to obtain first double-processed data (the second shift is performed when the value of the first double-integrated data goes beyond a value range that is acceptable for the subsequent processing of said data).

The shifts are based on the same principle as described above.

A batch of location data from t₀ to tₖ is thus obtained, in which:
the second integrated data from t₀ to tₖ are representative of an angular position (or an orientation);
the first integrated data from t₀ to tₖ are representative of a linear velocity;
the first double-integrated data from t₀ to tₖ are representative of a linear position.

The batch of location data from tₖ₋₁ to tₖ, the batch of location data from t₀ to tₖ and time information for both (an counter integration-step or time-step of the inertial measurement unit between the sampling time and the integration start time, i.e. tₖ−t₀ here) are transformed into a packet that is introduced into second signals at tr transmitted via the data link 300 to the electronic navigation calculation unit 200. These second signals at tr are the location signals at tₖ.

The second program executed by the electronic navigation calculation unit 200 is arranged to extract the processed data and the time information from the second signals at tᵢ and implements an inertial navigation algorithm to process them in order to calculate the inertial location while taking into account the evolution of the integration period since the last extraction of the second signals.

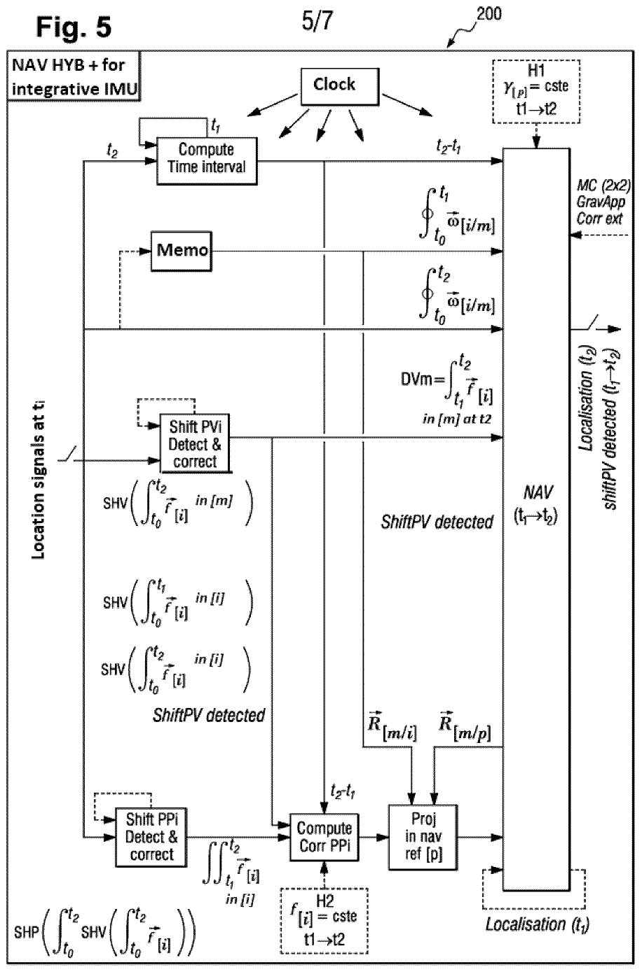

More precisely, with reference to FIG. 5, the second program receives, as an input, the second signals at tᵢ in the form of two data packets that are transmitted at each time tᵢ by the first program but recovered, respectively, at the time tₜ then at the time t₂, for example, each comprising the first processed data, the first double-processed data, the second processed data and the time information corresponding to the sampling time of the pseudo-navigation data in the inertial measurement unit together with any internal drifts of the clock of the inertial measurement unit (this time information is a number of integration steps of the inertial measurement unit since the single integration start time to, associated with the data packet transmitted by the inertial measurement unit).

The two times t1 then t2 are separated by less than half the minimum time between two successive shifts of a component of the inertial pseudo-velocity or pseudo-position.

Considering, for the simplicity of the description, that the data received at the time t₁ have already been processed, the second program has to carry out the operations for calculating the following on the basis of the data received at the time t₂:
the three components of the variation in the inertial pseudo-velocity from tᵢ to t₂ in the measurement frame of reference [m], denoted by DVm(t₁->t₂), said components having been corrected for the effect of a shift SHV;
the three components of the variation in the inertial pseudo-velocity from tᵢ to t₂ in the inertial frame of reference [i], denoted by DVi(t₁->t₂), said components having been corrected for the effect of a shift SHV;
the three components of the variation in the inertial pseudo-position from t₁ to t₂ in the inertial frame of reference [i], denoted by DP (t₁->t₂), said components having been corrected for the effect of a shift SHP;
the three correction components of the inertial pseudo-position from tᵢ to t₂ in the inertial frame of reference [i], denoted by CorrPPi(t₁->t₂),
a logic indicator ShiftPVdetected for detecting a shift of at least one of the pseudo-velocity components between t₁ and t₂.

It is noted that the data received at the time t₁ and the data received at the time t₂ have been integrated from the integration start time t₀. It is therefore sufficient to subtract the data received at the time t₁ from those received at the time t₂ in order to obtain the data corresponding to the time interval t₂−t₁. The rate dtₖ=t₂−t₁ determines the precision of the calculation of the evolution of the position and the inertial attitude from t1 to t2. The error due to the sampling rate is substantially generated in the variable acceleration phase. It is equivalent to approximately +/−(g/R)*(dtₖ/2)² and +/−(2g/R)*(dtₖ/2)² of projection error or, for dtₖ=4s, the equivalent of 6 and 12 ppm of horizontal and vertical accelerometric scale factor error, in urad of horizontal attitude and heading error, where
g is the average terrestrial gravity≅9.81 m/s\hat{ }2 (at 0 m),
R is the Earth's average radius of curvature≅6,400,000 m,
or √(R/g)≅800 s.

It should be ensured that no data are lost at the output at the rate dtₖ (a rate much lower than 500 s is selected, for example 4 s or 10 s).

Furthermore, the second program has the shift values stored and is arranged to analyse the values of the transmitted processed data and to detect the presence of a shift. The analysis involves comparing each of the components of the most recently received processed data with each of the components of the processed data received the previous time and detecting therein any inconsistency in consideration of the laws of physics. If any such inconsistency exists, this means that a shift has occurred, and the second program then considers the indicator ShiftPVdetected to be true and compensates for the implemented shift by using the corresponding shift value. Otherwise, the second program considers the indicator ShiftPVdetected to be false.

The second program calculates the evolution of the inertial location from t₁ to t₂ from the following information:
inertial attitude (transmitted by the electronic processing circuit 130) at t₁ and t₂,
variation in the inertial pseudo-velocity in the inertial frame of reference from t₁ to t₂,
length of time t₂−t₁,
location at t₁.

In a manner known per se, the second program is also arranged to process:
the curvature matrix MC for determining the local curvature of the reference ellipsoid for the navigation,
the local apparent gravity GravApp (locally perpendicular to the ellipsoid),
an external correction factor Corr ext for correcting the calculation of apparent gravity so as to stabilise, at an average, the altitude on an external altitude reference (in an aircraft, this altitude reference comes, for example, from an anemo-barometric unit).

The second program performs these calculations of the evolution of the inertial location from tᵢ to t₂ on the assumption H1 that the apparent acceleration V_{P} is constant in the navigation frame of reference between t₁ and t₂.

These calculations are t then corrected by taking into account the three correction components of the inertial position from t₁ to t₂ in the inertial frame of reference [i].

The three correction components of the inertial position from t₁ to t₂ in the inertial frame of reference [i], CorrPPi (t₁->t₂), are calculated as follows:
if ShiftPVdetected is false (no velocity shift), then CorrPPi(t₁->t₂)=DP(t₁->t₂)−(PV(t₁)+PV(t₂))*(t₁−t₂)/2
if ShiftPVdetected is true (there has been a velocity shift between t₁ and t₂), then the value of CorrPPI cannot be calculated and is arbitrarily set to 0, i.e. CorrPPi(t₁->t₂)=0

This calculation is performed on the assumption H2 that the acceleration f_{[i]} in the inertial frame of reference [i] is constant. The difference between the assumptions H1 and H2 is mainly due to the apparent gravitational rotation seen from the navigation reference frame p in the inertial frame of reference [i]. For horizontal mechanised navigation on the terrestrial, free-azimuth reference ellipsoid, this difference has a negligible effect on the calculated position-deviation correction term CorrPPi (t₁->t₂). It is understood that the indicator ShiftPVdetected is determined in order for the evaluation of the variations in inertial location errors to be refined according to the potential dynamics of the carrier at that time.

The second program corrects the inertial location using a deviation CorrPi calculated as follows:
projecting the components of CorrPPi (t₁->t₂) in the navigation reference frame [p] from the inertial reference frame [i], which gives the correction components CorrPPp(t₁->t₂), using:
   the inertial attitude transmitted by the electronic processing circuit 130 at t₁ and possibly at t₂,
   the attitude of the navigation at t₁;
calculating the equivalent rotation correction of the attitude and calculating the horizontal position on Earth of the horizontal location by using the apparent gravity (GravApp) and the matrix MC (2×2) of the local curvature of the terrestrial ellipsoid of the navigation in the horizontal navigation frame of reference (or platform frame of reference) [p] and the two horizontal correction components CorrPPp(t₁->t₂);
taking this additional rotation into account in the calculations of the evolution of the inertial location from t₁ to t₂;
adding the vertical correction component CorrPPp(t₁->t₂) to the altitude at t₂, which is the result of calculating the evolution of the inertial location from tᵢ to t₂ to obtain CorrPi.

Here, the inertial location is used directly to enable the navigation of the aircraft A.

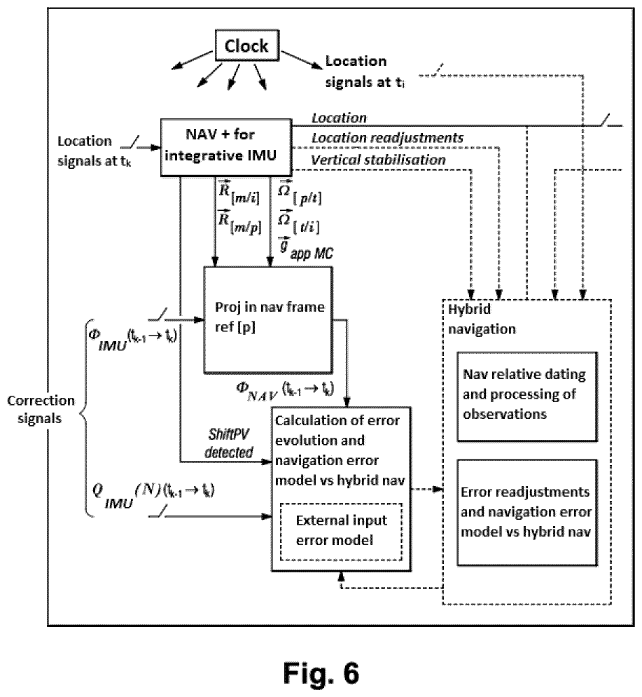

At the same time, the second program also receives second signals at tr and is arranged to extract, from the second signals at tr, the batch of data from tₖ₋₁ to tₖ, the batch of data from tₖ and the time information, and implements a hybrid navigation algorithm to process them in order to calculate a hybrid location (see FIG. 6).

The hybrid navigation algorithm receives, as an input, the location signals at tₖ and external location data (satellite location data, star tracker data, radar location data, etc.).

The hybrid navigation algorithm comprises a Kalman filter, which is known per se, and a hybrid navigation error model for calculating a hybrid location of the aircraft A.

The electronic processing circuit of the inertial measurement unit 100 is arranged to transmit a time marker (“Time Mark” in FIG. 3) to the electronic navigation calculation unit 200 in order to synchronise the navigation calculations and to date the signals transmitted by the inertial measurement unit 100. This is particularly important in order for the hybrid navigation to be dated with respect to the external information that it processes (it is understood that to calculate a hybrid location at a time t, it is necessary to link inertial location data and external location data corresponding to said time t).

The second program corrects the hybrid location by using the correction signals.

The generation of the correction signals will now be explained below.

The electronic processing circuit 100 is provided with a memory containing an error model of the inertial sensors. The electronic processing circuit 100 is arranged to calculate:
from the error model, first correction data Φ_{IMU} which are representative of an impact of the sensor errors on the location signals over a given period (for example from tₖ₋₁ to tₖ) and which are determined by the electronic processing circuit,
second correction data Q_{IMU} representative of the noises of the model over the given period.

More precisely, the first correction data Φ_{IMU} here are the components of a matrix of the evolution of the nine location errors in the navigation frame of reference [i]. The nine error states correspond to the three attitude error states, the three pseudo-velocity error states and the three inertial pseudo-position error states. Said matrix may comprise other states representative of, for example, the impact of the six gyrometric misalignment errors, the six accelerometric misalignment errors, the scale factor errors of the accelerometers and gyroscopes, etc. The components of the error evolution matrix are calculated using the error model of the sensors of the inertial measurement unit 100 together with measurements of the environment of the inertial measurement unit 100, which are supplied by at least one sensor (for example a temperature sensor, a moisture sensor, a magnetic radiation sensor, etc.) arranged near the inertial measurement unit 100 and which are used as an input to the error model. It should be noted that the calculation of the components of the error evolution matrix is known per se and therefore is not explained herein.

The second correction data Q_{IMU} are the components of a vector representative of the uncertainties of the error model. This is also referred to as a desensitisation matrix or a noise matrix, which may or may not be diagonal. It should be noted that the calculation of the components of the noise matrix of the model is known per se and therefore is not explained herein. Here, there are 81 first data (N×N) and nine second data (N). In this case, the values of the non-zero and non-fixed components of the error evolution matrix and of the three components of the noise matrix of the model are encoded as a floating point on 32 bits or 64 bits.

The electronic processing circuit 100 then transforms the first correction data and the second correction data into correction signals.

It is noted that here the electronic processing circuit 100 is programmed to transmit the following to the electronic navigation calculation unit 200:
firstly, at a first rate, location signals, and
secondly, at a second rate lower than the first rate, signals for correcting the location signals.

Here, the second rate is a sub-multiple of the first rate. It should be noted that the given period used for the correction data is sliding from tₖ₋₁ to tₖ, then from tₖ to tₖ₊₁, then from tₖ₊₁ to tₖ₊₂ and so on in order to limit the volume of data to be transmitted. It is therefore essential that the electronic navigation calculation unit 200 has all the correction signals.

It is also important that the content of the location signals at tr and the content of the correction signals are homogeneous in time so that the data contained in each correction signal do indeed correspond to the data contained in the location signals corresponding to the given period. There is therefore synchronisation between the generation of each correction signal and the generation of the location signals during the given period.

The second program executed by the electronic navigation calculation unit 200 is arranged to extract the first correction data and the second correction data from the correction signals. With reference to FIG. 6, the second program calculates, by using a navigation algorithm fed by the location signals at tₖ and in particular by the batch of location data from tₖ₋₁ to tₖ, the following:
the rotation of the measurement frame of reference [m] relative to the inertial frame of reference [i], i.e. \vec{R}_{[m/u]};
the rotation of the measurement frame of reference [m] relative to the navigation frame of reference [p], i.e. \vec{R}_{[m/p]};
the rotational velocity of the navigation frame of reference [p] relative to the terrestrial frame of reference [t], i.e. \vec{Ω}_{[p/t]};
the rotational velocity of the terrestrial frame of reference [t] relative to the inertial frame of reference [i], i.e. \vec{Ω}_{[t/i]}.

With these rotations and rotational velocities, as well as the apparent gravity \vec{g}ₐₚₚ and the local curvature matrix MC, the second program projects the first correction data Φ_{IMU}(tₖ₋₁ to tₖ) into the navigation frame of reference [p] and thus obtains the first projected correction data Φ_{NAV}(tₖ₋₁ to tₖ). Using the first projected correction data Φ_{NAV}(tₖ₋₁ to tₖ), the second correction data Q_{IMU}(tₖ₋₁ to tₖ) and the shift indicator ShiftPVdetected of the batch of data from t₀ to tₖ (obtained by the second program in the same way as for the signalling data at tᵢ), the second program calculates the error evolutions and the navigation error model, which are then transmitted to the hybrid navigation algorithm in order to readjust the hybrid navigation error model, and therefore the hybrid location, and to the inertial navigation algorithm in order to readjust the inertial location too.

The second program supplies the inertial location of the aircraft A and the hybrid location of the aircraft A (the location groups together the information regarding attitude, velocity and terrestrial geographical position).

It should be noted that, preferably, the electronic navigation unit has a working period of less than half the minimum time between two successive shifts.

In the described method, the increments are integrated, by the inertial measurement unit, in an inertial frame of reference (within the limits of sensor faults) so as to enable navigation calculations on a terrestrial reference ellipsoid at a lower rate and in an asynchronous manner. The use by the second program of the outputs of the inertial measurement unit in the event that shifts are possible is based on the knowledge and processing of the inertial pseudo-velocity and pseudo-position shift values before the evolution of the inertial location is calculated.

It is understood that the transmission of the matrix Φ_{IMU} (tₖ₋₁→tₖ) forming the first correction the hybrid navigation(s) allows it/them to:
firstly, calculate the inertial location evolution from tₖ₋₁ to tₖ of the inertial measurement unit, with first-order linearisation for the effect of the estimated error parameters, and
secondly, calculate the matrix that models, likewise in a first-order manner, the effect of the non-estimated residual errors of the inertial measurement unit on the evolution of the hybrid inertial location error from tₖ₋₁ to the before any readjustments at tₖ and after any readjustments at tₖ₋₁.

It is noted that the first-order-linearised correction disregards the combined effects of specific force error and gyrometric measurement error between tₖ₋₁ and tₖ on the uncorrected outputs of the inertial measurement unit.

For lengths of time dtₖ of 1 to a few tens of seconds, depending on the trajectory dynamics of the carrier vehicle, and for apparatuses that enable precise pure inertial navigation and, for most inertial systems, enable the generation of an air speed-assisted attitude and heading function (Attitude and Heading Reference Systems, AHRS), the errors due to said approximation are negligible considering the non-compensable residual inertial measurement errors.

The taking into account, by calculation, of the parameters of the error model of the inertial measurement unit, which are estimated by the hybrid navigation at tₖ₋₁ for the estimated evolution of the hybrid location, uses the first projected correction data Φ_{NAV} (tₖ₋₁→tₖ), the second correction data Φ_{IMU} (tₖ₋₁→tₖ), the values estimated by the hybridisation and the matrices or quaternion or rotation Tp/t, Tp/m, Tm/i (or Tp/t, Tp/m, Tp/i_{c}, Tm/i and Tm/i_{c}) at tₖ₋₁ and at tₖ.

To simplify the calculation of @NAV (which is the error evolution matrix in the navigation frame of reference [p]) from Φ_{IMU} (which is the error evolution matrix in the inertial frame of reference [i]), the compensated inertial frame of reference [i_{c}] (i.e. the inertial frame of reference [i] compensated for by taking account of the inertial measurement unit errors) has been introduced in this case. Specifically, the frame of reference [i] calculated by the outputs Φ_{IMU}, PVI and PPI (values in m/s and m supplied in the frame of reference [i]) is not perfect because its calculation contains errors of the inertial measurement unit. These errors are modelled in the inertial measurement unit, and their quantitative effect, which is dependent on gyrometric and accelerometric error parameters, is supplied to the hybrid navigation at each evolution step from tₖ₋₁ to tₖ via the matrix Φ_{IMU}(tₖ₋₁→tₖ). The values of some of these parameters are estimated and readjusted by the Kalman filter, which is also based on the matrix Φ_{IMU}(tₖ₋₁→tₖ) and therefore on the error model that the matrix uses. These values of the error state sub-vector are used to generate, via the evolution matrix, the angular drift of the frame of reference [i] calculated by the inertial measurement unit for the hybrid inertial navigation. This results in:
the three angular error values added in order to calculate Tp/i corrected at t₂ and the average drift between tₖ₋₁ and tₖ to be taken into account to calculate the “projection in [p]” via a matrix M_{p/i}(tₖ₋₁ tₖ) (not generally rotational) for the pseudo-velocities and a matrix MM_{p/i}(tₖ₋₁ tₖ) for the corrections of inertial pseudo-positions in the frame of reference [i];
the three pseudo-velocity error values in [i] to be added in order to calculate PVI(tₖ)−PVI(tₖ₋₁), corrected for the error parameters estimated at tᵢ by the Kalman filter;
the three pseudo-position error values in [i] to be added in order to calculate PPI(tₖ)−PPI(tₖ₋₁), corrected for the error parameters estimated at tr by the Kalman filter.

This compensation can be used to calculate the evolution of Tp/i from tₖ₋₁ to tₖ; it also makes it possible to calculate (although this is not useful for hybrid navigation) a compensated inertial frame of reference [i_{c}] which is closer to an inertial frame of reference owing to the corrections of the gyrometric errors of parameters estimated and readjusted by the hybrid navigation. It should be noted, however, that the compensated inertial frame of reference [i_{c}] is not actually used for calculating the navigation. Furthermore, the compensated inertial frame of reference [i_{c}] is not needed in order to calculate the evolution, from tₖ₋₁ to tₖ, of Tp/i, Tp/t, Tp/m, V_{z}, H and the horizontal velocity in the horizontal free-azimuth frame of reference [p] on the reference ellipsoid.

It is noted that:
if there are no modelled gyrometric errors (so-called “pure IMU” navigation), then [i]=[i_{c}],
otherwise, the rotation of estimated gyrometric errors from tₖ₋₁ to tₖ in [i_{c}] is calculated in matrix form by, for example,

$$\begin{matrix}Tm / {i}_{c} ( {t}_{k} ) = Tm / {i}_{c} ( {t}_{k - 1} ) * Tm / i ( {t}_{k} ) \\ * Rot ( [ - Φ {IMU ( {t}_{k - 1} \to {t}_{k} )}_{angular error status lines} * {\hat{X}}_{p} ) \\ * Ti / {i}_{c} ( {t}_{k - 1} )\end{matrix}$$

where \hat{X}ₚ represents the values of the parameter states estimated at tₖ₋₁, where Ti_{c}/i≠the identity matrix and

Tp/m(tₖ)=Tp/t(tₖ)*Tt/i_{c}(tₖ)*Tm/i_{c}(tₖ)^{t}

The evolutions in the matrices (or the quaternions/vector representing rotations) Tp/t, Tp/m and Tp/i_{c} from tₖ₋₁ to tₖ, before any readjustments at tₖ, are obtained by repeating the calculation of the rotational evolution of the navigation frame of reference [p] to the frame of reference [i_{c}] from tₖ₋₁ to tₖ as a function of:
the average analytical platform horizontal specific force from tₖ₋₁ to tₖ,
the correction Tp/i_{average}*CorrPPI(tₖ₋₁→tₖ) in average horizontal components in the navigation frame of reference [p] from tₖ₋₁ to tₖ,
the local curvature of the ellipsoid at the average altitude from tₖ₋₁ to tₖ,
the average vertical velocity from tₖ₋₁ to tₖ.
   The curvature generated by the non-spherical reference ellipsoid varies very little and only with latitude and altitude. The curvature matrix can therefore be approximated by a constant (or a linear function as a function of time) over a duration dtₖ without generating significant errors in the calculation of the location evolution. Thus,
a latitude variation of 5000 m (during dtₖ) generates a relative variation in the curvatures, at the most unfavourable latitude, of at most a few ppm;
an altitude variation of 1000 m (in dtₖ) generates a relative variation in the curvatures of approximately 1/6400 or, at 250 m/s, a maximum error of approximately 4 cm/s. This error is eliminated, except for dynamic phases with vertical acceleration, by using the average altitude over dtₖ for calculating the curvature matrix.
   The evolution in the vertical velocity from tₖ₋₁ to tₖ, before any readjustments, is obtained by integrating:
the average vertical specific force, corrected for local gravity, estimated at tₖ₋₁,
an apparent gravity correction,
a velocity stabilisation correction,
vertical velocity errors generated by the estimated IMU errors (\hat{X}ₚ).

The evolution of the altitude from tₖ₋₁ to tₖ is obtained by partially integrating the vertical velocity by adding the correction equal to the vertical component of

$${( Tp / {i}_{c} * {Ti}_{c} / i )}_{average of tk - 1 to tk} * Corr PPI ( {t}_{k - 1} \to {t}_{k} ) .$$

After integration, an external altitude stabilisation loop or the reference altitude Kalman filter at tₖ (for example the barometric altitude) makes it possible to calculate the theoretical apparent gravity value at the altitude at tr, the new corrections to the apparent gravity value and possibly the vertical velocity at tₖ, which are applicable for the following time step from tₖ to tₖ+1.

The taking into account of the error model of the inertial measurement unit in the error evolution model of the free-azimuth ellipsoidal hybrid location uses the matrix Φ_{IMU} tₖ₋₁→tₖ and the matrices or quaternion or rotation Tp/m, Tp/i, Tm/i at tₖ₋₁ and at tₖ (values at tₖ obtained by repeating the evolution calculation from tₖ₋₁ to tₖ).

In addition, the error parameter states of the inertial measurement unit are added to the navigation error model. This allows them to be taken into account in the error evolution model of the hybrid location and possibly the estimation and real-time updating of parameters of the error model of the inertial measurement unit during readjustments. This is often the case with accelerometer biases, for example.

The method of the invention provides several improvements to simplify real-time implementation of hybrid navigations using digital links between the inertial measurement unit and the electronic navigation unit.

These improvements allow the evolution of the hybrid inertial location to be calculated at a low rate (for example from 1 s to 10 s depending on the desired precision for the evolution calculation and depending on the dynamic evolution range of the carrier).

The data from this hybrid location have a high delay (e.g. 8 s) due to:
data calculation and transmission delays by the hybrid integrative inertial measurement unit (e.g. 4 s);
delays in calculating the evolution of the hybrid inertial location (e.g. 4 s);
delays (e.g. 2 s) in transmission to a high-frequency calculation module (typically 2 to 10 ms), and the taking into account of low-delay outputs by this high-frequency calculation module.

It is possible to calculate operational hybrid navigation outputs having a low delay (typically 4 to 20 ms).

The corresponding navigation calculations are fed:
firstly, the low-delay, high-rate (typically 2 to 10 ms) inertial attitude, inertial pseudo-velocity and inertial pseudo-position data,
secondly, the low-rate and thus high-delay data from the hybrid navigation;
and, thirdly, the time, inertial attitude output, inertial pseudo-velocity and inertial pseudo-position data supplied by the inertial measurement unit to the iso-dated hybrid inertial navigation.

It is noted that in the advantageous version of the invention described here, the first program executed by the electronic processing circuit 130 is arranged to perform a third integration on the first double-integrated data of the location data from tₖ₋₁ to tₖ in order to obtain first triple-integrated data over the time step in question. The first triple-integrated data are transmitted to the electronic processing unit 200, which uses them to refine the navigation. The first triple-integrated data from tₖ₋₁ to tₖ are used to improve precision.

Specifically, pseudo-location data are initially available in the inertial frame of reference [i], but the aim is to obtain a navigation in the navigation frame of reference [p].

It is therefore necessary to calculate the transfer matrix for transferring from [i] to [p]. To do this, it is assumed that the specific force f is constant (ramp).

The transfer matrix Ti/p is usually the sum of matrices composed of the coefficients of Legendre polynomials.

With the single integration and the double integration of the first data from tₖ₋₁ to tₖ, it is possible to calculate a transfer matrix in the form of a first matrix composed of the coefficients of the Legendre polynomials of order 0 and a second matrix composed of the coefficients of the Legendre polynomials of order 1.

With the third integration of the first data from tₖ₋₁ to tₖ, it is possible to refine the calculation of the transfer matrix Ti/p by also calculating the coefficients of the Legendre polynomials of order 2 of a third matrix added to the sum of the previous ones. This results in an increase in navigation precision.

It goes without saying that the invention is not limited to the described embodiment but covers any variant falling under the scope of the invention as defined by the claims.

In particular, the device may have a different structure from that described.

For example, the electronic processing circuit and the electronic navigation calculation unit may have different structures from those described and may comprise, for example, a coprocessor, a dedicated ASIC-type processor, a microcontroller, an FPGA-type programmable circuit, etc.

Although the invention is particularly advantageous when the inertial measurement unit and the electronic processing unit are very far apart (for example several metres apart), the invention is also applicable when the inertial measurement unit and the electronic processing unit are closer together (for example less than one metre apart).

Computer programs may be arranged differently and perform calculations with different levels of precision.

It is noted in particular that the precision may be significantly improved merely by providing the correction signals comprising first correction data, which are representative of an impact of the sensor errors on the location signals over a given period and which are determined by the electronic processing circuit from the error model, and second correction data, which are representative of an effect of the random noises and errors of the inertial measurement unit over the given period, and by these correction signals being processed by the navigation calculation unit. The other features of the embodiment described (such as integration from a single integration start time or triple integration) are certainly advantageous but are optional.

Shifting operations are not needed when the integration period is such that the processed data supplied have a value that is compatible with the expected resolution for the navigation.

The outputs of the electronic processing circuit may be supplied at a fixed rate (possibly configurable via a circuit initialisation command) or on external request, in which case the program making the request is responsible for ensuring the request rate is sufficient so as not to risk the same data being shifted more than once between two data supplies.

Preferably, the attitude outputs (gyrometric data), the velocity outputs and position the outputs (from the accelerometric data) are all limited to 22 or 24 bits per output, with a sufficient resolution to ensure that the drop in navigation precision with the method of the invention is negligible compared with the precision of navigation carried out directly on the basis of the increments from the sensors. The described shifts allow the number of bits of the velocity and position outputs to be reduced.

The outputs of the electronic processing circuit enable inertial navigation that:
is synchronous or asynchronous,
is precise even when the outputs are processed at a rate greater than a few seconds and for a dynamic trajectory,
is robust against multiple interruptions potentially-lasting up to several seconds, or more than one minute when static,
does not lead to the electronic navigation calculation unit being overloaded in the event of data loss.

Preferably, the first program executed by the electronic processing circuit has an initialisation mode by which all or some of the following parameters can be modified:
orientation of the measurement frame of reference,
clocked output or output on request,
output rate,
type of velocity output in the inertial frame of reference (it should be noted that the output by components in the measurement frame of reference [m] makes it possible to calculate the components in the inertial frame of reference via the supplied rotation quaternion Qi/m for transferring from [m] to [i]),
shift thresholds,
shift values,
scale factor bias or errors, etc.

Preferably, to minimise the projection error in the navigation frame of reference, navigation with inertial or horizontal free-azimuth mechanisation (and navigation frame of reference) on the terrestrial ellipsoid is selected. However, this is not mandatory.

Preferably, the effects of the variation in gravity, local curvature of the ellipsoid and Coriolis acceleration between the times to and the are disregarded.

In the event that a plurality of shifts have to be carried out after a single integration, it is necessary to add a shift counter to the data packet so that the electronic calculation unit can retrieve the number of shifts carried out.

The length of time between two shifts can range from a few seconds to a few tens of seconds depending on the dynamics of the vehicle carrying the navigation device.

Preferably, to maintain good navigation precision, the number of shifts per hour is limited. For example, with outputs encoded on 24 bits, the maximum number shifts of is advantageously three per 400-s period, and with outputs encoded on 32 bits, the maximum number of shifts is advantageously three per 28-hour period.

The device may comprise one or more inertial measurement units, arranged or not arranged near one another, at any point on the aircraft and in particular not necessarily near the centre of gravity.

Integrations are optional if the risk of erroneous data transmission between the inertial measurement unit 100 and the electronic navigation calculation unit is sufficiently low as to be acceptable with regard to the envisaged application.

In a basic navigation form, it is possible to reconstruct the increments at the conventional navigation rate from the differences between two successive sets of output data of the inertial measurement unit. The inertial navigation can be kept at this rate in the same way as with conventional navigation. In this case, the correction vector CorrPPi is systematically zero.

The location signals can be generated differently from those described and correspond, for example, solely to data integrated from successive integration start times and not from a single integration start time.

The correction signals may feed into one or more hybrid navigation algorithms.

The first rate may be between 100 Hz and 400 Hz, and the second rate may be between 0.1 Hz and 1 Hz; alternatively, the values may be different from these. The rates may be identical to each other. The respective transmission rates of the signals may be different from those stated.

As an option with regard to the rate, for use cases with very high precision and dynamic evolution, it is possible to opt to transmit one to three groups of output values defined below at times spread over the time interval t1 to t2. With uniform distribution, an evolution calculation error is obtained due to the rate, which is reduced by four for one additional intermediate dataset and reduced by sixteen for three additional intermediate datasets. It is noted that a higher rate of 10 s, for example, generates greater errors than those of a GNSS hybrid navigation; the formula indicated above in the description gives 38 urad of horizontal projection error. It is greater than the instability of the accelerometric scale factors in navigation and the typical residual attitude errors of 30 μrad that can be obtained by, for example, inertial navigation which is hybridised with a GNSS receiver and which uses an inertial measurement unit that is sufficiently precise as to achieve a typical pure inertial horizontal navigation error of between one and a few nautical miles per hour.

The correction data used to readjust the hybrid location may come from any source external to the inertial navigation, for example the positions of a radiolocation receiver, but this is not the only option (star tracker or the like).

The worst-case error in the calculation of the specific force projection due to the time discretisation (t₂−t₁) is ωs²*(t₂−t₁)²/2 in the vertical and ωs²*(t₂−t₁)²/4 in the horizontal, where ωs is the Schuler impulse (approximately 1/840 rad/s). A time step (t₂−t₁) of four seconds may sometimes not be sufficiently precise for some applications. Sending Ti/m, PPi and PVi data at intermediate times between t1 and t2 (at 1 s or three groups of intermediate values Ti/m, PVi and PPi, where t2−t1=4s, for example) makes it possible to sufficiently reduce this error (by a factor of 16 in the example).

The invention can be implemented by calculations other than those presented in detail and, for example, without using the corrected inertial frame of reference.

The invention is applicable to any type of vehicle, whether land, water or air.

For hybrid navigation that processes signals from a Doppler radar or a vehicle travelling on a predetermined path, such as a rail-borne vehicle (the direction of travel being fixed relative to the vehicle platform, thus defining the reference trihedron [b]), the following are preferably used to calculate the distance travelled as seen from the moving reference:
the simple integral over Δt of the transfer matrix for transferring from the frame of reference [i] to the frame of reference of the platform [b] (i.e. nine values);
the double integral over Δt of the transfer matrix for transferring from the frame of reference [i] to the frame of reference of the platform [b] (i.e. nine values);
the triple integral over Δt of the transfer matrix for transferring from the frame of reference [i] to the frame of reference of the platform [b] (i.e. nine values);
the double integral of the specific force over Δt (i.e. three values).

This makes it possible to hybridise with models that do not have velocity components transverse to a fixed or semi-fixed direction relative to the inertial measurement unit.

1. A navigation device comprising an inertial measurement unit and an electronic navigation calculation unit that are connected to each other by a data link, the inertial measurement unit comprising inertial sensors for producing location signals, and the electronic navigation calculation unit being arranged to calculate a navigation from the location signals, wherein the inertial measurement unit comprises an electronic processing circuit that is connected to the inertial sensors and provided with a memory containing an error model of the inertial measurement unit; in that the electronic processing circuit is arranged to transmit to the electronic navigation unit, firstly, at a first rate, said location signals and, secondly, at a second rate, correction signals comprising first correction data, which are representative of an impact of the sensor errors on the location signals over a given period and which are determined by the electronic processing circuit on the basis of the error model, and second correction data, which are representative of an effect of the random noises and errors of the inertial measurement unit over the given period; and in that the electronic navigation calculation unit implements a hybrid navigation algorithm arranged to supply a hybrid location that is based on inertial location data extracted from the location signals and from the external location data and that is readjusted on the basis of the correction data.

2. The device according to claim 1, wherein the first correction data are defined in an inertial frame of reference, and the electronic navigation calculation unit is arranged to use the location signals to project the first correction data into a navigation frame of reference.

3. The device according to claim 1, wherein the electronic processing circuit is arranged to transmit a time marker together with the location signals, and the hybrid navigation algorithm processes the time marker in order to match the inertial location data to the external location data in the hybrid navigation algorithm.

4. The device according to claim 1, wherein the second rate is lower than the first rate, and the second rate is preferably a sub-multiple of the first rate.

5. The device according to claim 1, wherein the electronic processing circuit is arranged to perform at least a first integration, as a function of time, of primary data contained in primary signals from the inertial sensors over an integration period, which begins at a single integration start time and is measured, in order to produce processed data inserted into signals forming the location signals together with time information representative of the integration period, and in that the electronic navigation calculation unit is arranged to extract the processed data and the time information from the location signals and to process them in order to calculate the navigation while taking the integration period into account.

6. The device according to claim 5, wherein the electronic processing circuit is arranged to perform a second integration on the result of the first integration of at least a portion of the primary data, the processed data comprising the result of the first integration and the result of the second integration.

7. The device according to claim 5, wherein the electronic processing circuit is arranged to compare at least a portion of the integrated data with at least a first threshold and, when the integrated data have a current value at least equal to the first threshold, to apply a first predetermined shift to the integrated data in order to bring the integrated data to a shifted value below the first threshold.

8. The device according to claim 5, wherein the electronic processing circuit is arranged to perform two successive integrations on at least a portion of the data and, when the double-integrated data have a current value above a second threshold, to apply a second predetermined shift to the double-integrated data in order to bring the double-integrated data to a shifted value below the second threshold.

9. The device according to claim 8, wherein the electronic navigation calculation unit is arranged, each time the data are received from the inertial measurement unit, to:
acquire an inertial attitude at the time of the current receipt and to store that of the previous receipt,
reconstruct, between two receipts, a variation in inertial pseudo-velocity in the inertial frame of reference, said variation having been corrected for the effect of the first shifts,
calculate, from the evolution of the position in the inertial frame of reference, corrected for the effect of the second shifts, a term that compensates for the fact that the acceleration (f[i]) in the inertial frame of reference [i] is not constant over the length of time between two receipts;
calculate an evolution in time between the current receipt and the previous receipt.

10. The device according to claim 5, wherein the electronic processing circuit is arranged to:
perform at least a first integration of at least a portion of the primary data, a second integration on the result of the first integration, and a third integration on the result of the second integration;
calculate, from the results of the first integration and the results of the second integration, a transfer matrix for transferring from the inertial frame of reference to the navigation frame of reference in the form of a first matrix composed of the coefficients of the Legendre polynomials of order 0 and a second matrix composed of the coefficients of the Legendre polynomials of order 1;
calculate, from the result of the third integration, the coefficients of the Legendre polynomials of order 2 of a third matrix added to the sum of the previous ones in order to refine the calculation of the transfer matrix.

11. A method for navigating by means of a navigation device comprising an inertial measurement unit and an electronic navigation calculation unit that are connected to each other by a data link, comprising the steps of:
in the inertial measurement unit:
generating location signals from measurements of inertial sensors and transmitting the location signals to the electronic navigation calculation unit at a first rate,
generating, from an inertial sensor error model stored in the inertial measurement unit, correction signals comprising first correction data, which are representative of an impact of the sensor errors on the location signals over a given period, and second correction data, which are representative of the dynamic noises representing the model errors over the given period, and transmitting the correction signals to the electronic navigation calculation unit at a second rate; and
in the electronic navigation calculation unit:
calculating, by using a hybrid navigation algorithm, a hybrid location that is based on inertial location data extracted from the location signals and the external location data,
readjusting the hybrid location on the basis of the correction data.

12. A vehicle containing at least one device according to claim 1.
